(19) United States
(12) Patent Application Publication
(10) Pub. No.: US 2020/0380541 A1
(43) Pub. Date: Dec. 3, 2020

(54) METHOD AND SYSTEM FOR ADJUSTABLE AUTOMATED FORECASTS

(71) Applicant: RUBIKLOUD TECHNOLOGIES INC., Toronto (CA)

(72) Inventors: Neil LAING, Kingston (CA); Waleed AYOUB, Toronto (CA); Iqbal HABIB, Pickering (CA); Martin MARK, Toronto (CA)

(21) Appl. No.: 16/496,784

(22) PCT Filed: Mar. 21, 2018
(86) PCT No.: PCT/CA2018/050340

§ 371 Date: Sep. 23, 2019

Related U.S. Application Data
(60) Provisional application No. 62/475,524, filed on Mar. 23, 2017.

(51) Int. Cl. G06Q 30/02; G06N 20/00

(52) U.S. Cl. CPC G06Q 30/0202; G06Q 30/0201; G06N 20/00; G06Q 30/0244

(57) ABSTRACT

A system and method generation of adjustable automated forecasts for a promotion. The method includes: determining, using a machine learning model, a set of forecasts each based on different parameters; determining at least one set of optimized parameters that maximize an outcome measure of the forecast for the promotion; generating a graphical representation of the forecast; receiving an adjustment to at least one parameter from a user; determining an adjusted outcome measure of the forecast for the promotion by applying the adjustment to the machine learning model; generating an adjusted graphical representation of the forecast; and displaying the adjusted graphical representation to the user.

### TECHNICAL FIELD

The following relates generally to predictive data processing, and more specifically, to a method and system for generation of adjustable automated forecasts for a promotion.

### BACKGROUND

It can be problematic in data science to provide data in a manner that is understandable and useable to a layperson. Certain data sets include copious amounts of data that has to be engineered and designed to provide a meaningful output or representation. Such output or representation, in some cases, can include providing forecasts or estimations based on input parameters. However, often, this includes “black-boxing” the data manipulations and merely providing an output or representation to the layperson based on the initial inputs.

It is therefore an object of the present invention to provide adjustable automated forecasts in which the above disadvantages are obviated or mitigated and attainment of the desirable attributes is facilitated.

### SUMMARY

In an aspect, there is provided a computer-implemented method for generation of adjustable automated forecasts for a promotion, the method comprising: receiving historical data related to one or more products and a plurality of previous promotions and their respective parameters; receiving at least one input parameter for the promotion from a user; determining, using a machine learning model trained or instantiated with a training set, a set of forecasts each based on different parameters, and determining at least one set of optimized parameters that maximize an outcome measure of the forecast for the promotion, the training set comprising the received historical data and the at least one input parameter; generating a graphical representation of the forecast having the maximized outcome measure; outputting the at least one input parameter, at least one optimized parameter, and the graphical representation of the forecast to the user; receiving an adjustment to at least one of the input parameters or at least one of the optimized parameters from the user; determining an adjusted outcome measure of the forecast for the promotion by applying the adjustment to the machine learning model; generating an adjusted graphical representation of the forecast having the adjusted outcome measure; and displaying the adjusted graphical representation to the user.

In a particular case, the method further comprising receiving a subsequent adjustment to at least one of the input parameters or at least one of the optimized parameters from the user, and performing: determining a subsequent adjusted outcome measure of the forecast for the promotion by applying the subsequent adjustment to the machine learning model; generating a subsequent adjusted graphical representation of forecast having the subsequent adjusted outcome measure; and displaying the subsequent adjusted graphical representation to the user.

In another case, the adjustment to the at least one of the input parameters or the at least one of the optimized parameters comprises removal of at least one of the input parameters or the optimized parameters.

In yet another case, the adjustment to the at least one of the input parameters or the at least one of the optimized parameters comprises changing a value of at least one of the input parameters or the optimized parameters.

In yet another case, the adjustment to the at least one of the input parameters or the at least one of the optimized parameters comprises changing weighting given to at least one of the input parameters or the optimized parameters by the machine learning model.

In yet another case, the adjustment to the at least one of the input parameters or the at least one of the optimized parameters comprises filtering possible states of the input parameters or the optimized parameters.

In yet another case, the machine learning model used to generate the forecasts can include one or more of predictive modeling, sensitivity analysis, basket analysis, root cause analysis, and regression analysis.

In another aspect, there is provided a system for generation of adjustable automated forecasts for a promotion, the system comprising one or more processors and a data storage device, the one or more processors configured to execute: an interface module to receive at least one input parameter for the promotion from a user; and a forecasting module to determine, using a machine learning model trained or instantiated with a training set, a set of forecasts each based on different parameters, and to determine at least one set of optimized parameters that maximize an outcome measure of the forecast for the promotion, the training set comprising a set of received historical data and the at least one input parameter, wherein the interface module generates a graphical representation of the forecast having the maximized outcome measure and outputs the at least one input parameter, at least one optimized parameter, and the graphical representation of the forecast to the user, the interface module receiving an adjustment to at least one of the input parameters or at least one of the optimized parameters from the user, wherein the forecasting module determines an adjusted outcome measure of the forecast for the promotion by applying the adjustment to the machine learning model, and wherein the interface module generates an adjusted graphical representation of the forecast having the adjusted outcome measure and displays the adjusted graphical representation to the user.

In a particular case, the interface module further receives a subsequent adjustment to at least one of the input parameters or at least one of the optimized parameters from the user, and wherein the forecasting module further determines a subsequent adjusted outcome measure of the forecast for the promotion by applying the subsequent adjustment to the machine learning model, the interface module generating a subsequent adjusted graphical representation of forecast having the subsequent adjusted outcome measure and displaying the subsequent adjusted graphical representation to the user.

In another case, the adjustment to the at least one of the input parameters or the at least one of the optimized parameters comprises removal of at least one of the input parameters or the optimized parameters.

In yet another case, the adjustment to the at least one of the input parameters or the at least one of the optimized parameters comprises changing a value of at least one of the input parameters or the optimized parameters.

In yet another case, the adjustment to the at least one of the input parameters or the at least one of the optimized parameters comprises changing weighting given to at least one of the input parameters or the optimized parameters by the machine learning model.

In yet another case, the adjustment to the at least one of the input parameters or the at least one of the optimized parameters comprises filtering possible states of the input parameters or the optimized parameters.

In yet another case, the machine learning model used to generate the forecasts can include one or more of predictive modeling, sensitivity analysis, basket analysis, root cause analysis, and regression analysis.

These and other embodiments are contemplated and described herein. It will be appreciated that the foregoing summary sets out representative aspects of systems and methods for adjustable automated forecasts to assist skilled readers in understanding the following detailed description.

### BRIEF DESCRIPTION OF THE DRAWINGS

The features of the invention will become more apparent in the following detailed description in which reference is made to the appended drawings wherein:

FIG. 1 is a schematic diagram of a system for adjustable automated forecasts in accordance with an embodiment;

FIG. 2 is a schematic diagram showing the system of FIG. 1 and an exemplary operating environment;

FIG. 3 is a flow chart of a method for adjustable automated forecasts in accordance with an embodiment;

FIG. 4 is a graph of an exemplary representation generated by the system of FIG. 1; and

FIG. 5 is an illustration of a user interface, according to an exemplary embodiment.

### DETAILED DESCRIPTION

Embodiments will now be described with reference to the figures. For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

The following relates generally to data processing, and more specifically, to a method and system for generation of adjustable automated forecasts for a promotion.

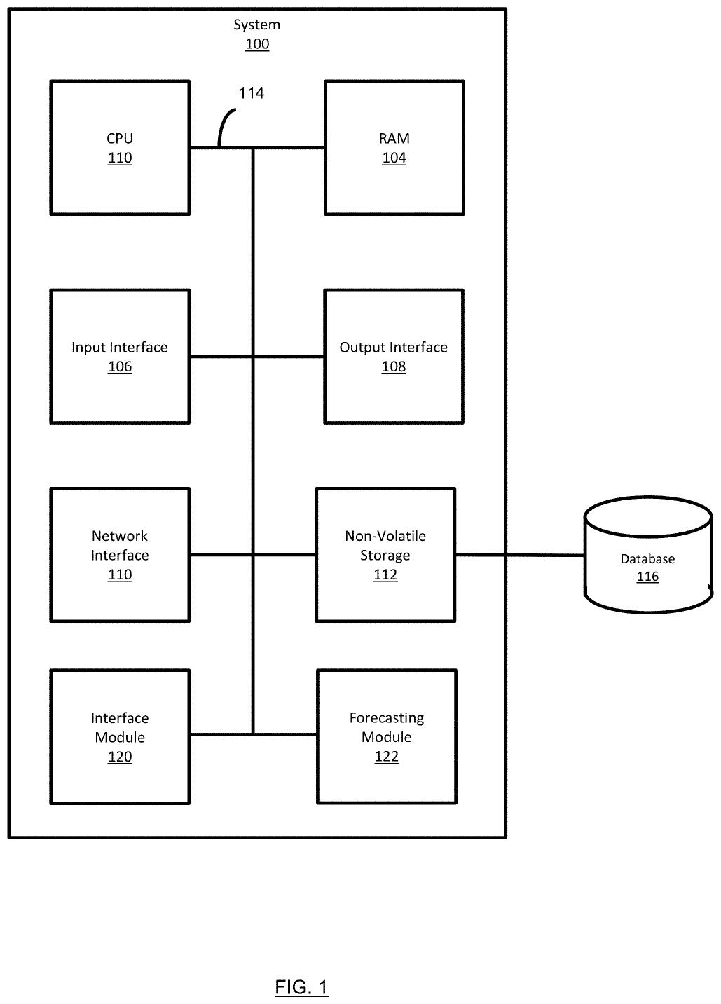

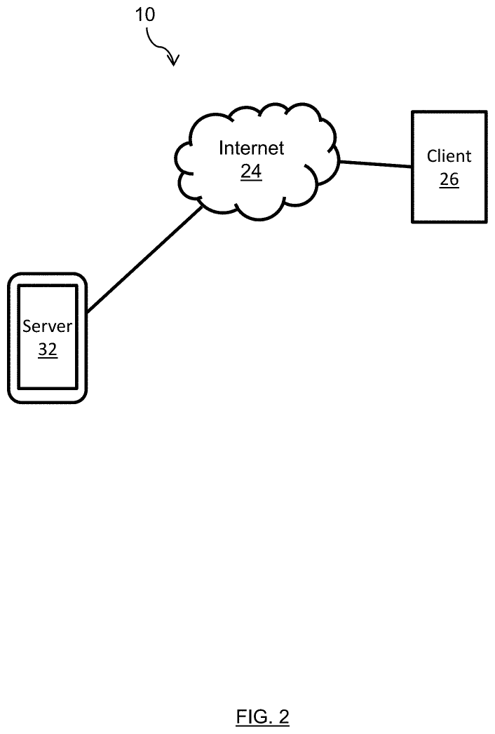

Referring now to FIG. 1, a system 100 for generation of adjustable automated forecasts for a promotion, in accordance with an embodiment, is shown. In this embodiment, the system 100 is run on a server. In further embodiments, the system 100 can be run on any other computing device; for example, a desktop computer, a laptop computer, a smartphone, a tablet computer, a point-of-sale (“PoS”) device, a smartwatch, or the like. Preferably, the system 100 is run on a server (32 in FIG. 2) and accessed by a client device (26 in FIG. 2) having a visual interface permitting a user to easily manage the manipulation of several potential variables, as will be explained below, which would typically include a display of at least several inches in diameter. Such an embodiment is typical of a web-based client interface for accessing a cloud-based server implementation. The system 100 enables the automated generation of manipulatable representations for presentation to a user.

As described further herein, the system 100 can make certain determinations based on inputted variables or settings. Based on such inputs, the system can arrive at an optimized solution based on determinations from a learned training set. The solution can be presented to the user through a representation or interface. The user can then actively manipulate the input parameters or settings to automatically change the outcome. Accordingly, the present embodiments advantageously provide a technological solution to the technical problem of developing a computing environment in which output outcome metrics are displayed and automatically adjusted, in real-time, in response to differing input parameters.

FIG. 1 shows various physical and logical components of an embodiment of the system 100. As shown, the system 100 has a number of physical and logical components, including a central processing unit (“CPU”) 102, random access memory (“RAM”) 104, an input interface 106, an output interface 108, a network interface 110, non-volatile storage 112, and a local bus 114 enabling CPU 102 to communicate with the other components. CPU 102 executes an operating system, and various modules, as described below in greater detail. RAM 104 provides relatively responsive volatile storage to CPU 102. The input interface 106 enables an administrator or user to provide input via an input device, for example a keyboard and mouse. The output interface 108 outputs information to output devices, such as a display and/or speakers. The network interface 110 permits communication with other systems, such as other computing devices and servers remotely located from the system 100, such as for a typical cloud-based access model. Non-volatile storage 112 stores the operating system and programs, including computer-executable instructions for implementing the operating system and modules, as well as any data used by these services. Additional stored data, as described below, can be stored in a database 116. During operation of the system 100, the operating system, the modules, and the related data may be retrieved from the non-volatile storage 112 and placed in RAM 104 to facilitate execution.

In an embodiment, the system 100 includes an interface module 120 and a forecasting module 122. To generate the output representation, the system 100 can use a machine learning model and/or statistical model to determine the output representation.

An exemplary application of the system 100 is the forecasting of retail metrics. These metrics could, for example, include forecasting particular sales figures that would result in view of particular promotions, where the promotions could include various permutations of demographically targeted promotions, co-product promotions, A/B testing, geographically targeted promotions, promotions available based on customer loyalty, promotions intended to attract new customers or retain existing customers, combinations of the foregoing, and the like. As will be appreciated, given the many potential combinations for designing the promotion, there are an inordinate amount of forecasts that would be considered by the user deciding the one or more input parameters for the promotion. In a typical use-case, a retailer would seek to implement a promotion to achieve a macroscopic objective or goal (referred to herein as a “macro-goal”), such as attracting new customers in a particular demographic, as an example. In some cases, the retailer may also seek a microscopic objective or goal (referred to herein as a “micro-goal”), such as achieving a particular revenue figure in a particular period. However, it is typical that the retailer would be constrained by non-statistical constraints (such as political, organizational, or other human-bias based constraints) preventing the personnel from simply moving forward with a machine-designed promotion. Thus, in some cases, it may advantageous for the personnel to alter what would otherwise be a recommended promotion design.

In a preferred embodiment, determining the forecasts takes place on the system 100, and the system 100 is equipped with or has access to considerable amounts of historical data relating to the specific application. For example, if the application is forecasting of retail metrics including promotions, the system 100 has access to considerable amounts of historical data exemplifying the real-world outcomes of past promotions. Thus, the system 100 can execute machine learning models or statistical models to create forecasts based on (1) the historical data; (2) the specific model(s) being used; (3) the needs of the user (retailer personnel) who may wish to achieve a certain macro-goal.

In most cases, many or all the input parameters have an effect on the output forecasts. The system 100 may generate forecasts based on historical data by analyzing how the input parameters might impact the forecasts in view of historical responses. The interface module 120 may be configured to generate forecasts based on analysis by the forecasting module 122 using a learned machine learning model. Training of the model may consist of taking in successive sets of input parameters, feeding through the machine learning model, and determining the accuracy of the output to known results. In this way, accuracy of the forecasts can be increasingly enhanced. In general embodiments described herein, the forecasting module 122 uses a previously trained machine learning model.

The value of the input parameters may then be optimized by the forecasting module 122 via the machine learning model in order to optimize a forecast output (the macroscopic objective, for example). In some cases, a best fit model could be employed to predict the outcome on the objective of changes to the input parameters based on analysis techniques, such as utilizing an evolutionary algorithm. In some cases, the forecasting analysis may rely on machine learning and/or neural network analysis. Broadly, the forecasting comprises a mapping of inputs to outputs, such as, for example, according to the function y=f(x). Based on a forecast y, and driven by a function for determining the forecast, the inputs x can be determined. Techniques employed in generating forecasts may include predictive modeling, sensitivity analysis, basket analysis, root cause analysis, and analysis of external factors. In some cases, the forecasting module 122 may model each user or user type by using a regression analysis. In some cases, the forecasting module 122 may predict missing digital data for each user based on like users.

The interface module 120 can then use the forecasts determined by the forecasting module 122 to generate a representation for the forecasts. In an example, the representation of the forecast may be in the form of, for example, graphs, text, charts, or the like.

The interface module 120 can display the representation to the user via the output interface 108.

In an embodiment, initially, the system 100, which has access to a user's own historical data, receives a macro-goal from the user via the input interface 106, applies a model trained using the user's own historical data and data from other sources, and provides a proposed promotion. The promotion can be output to the user via the output interface 108 as previously described.

Alternatively, initially, the system 100 receives initial values for the input parameters from the user via the input interface 106. The input parameters are then used by the forecasting module 122 to determine an optimized forecast. The optimized forecast is generally the forecast in which the output metric is objectively the highest for given outcomes. The interface module 120 generates a representation for the optimized forecast, and presents the representation to the user via the output interface 108.

While the optimized forecast is the optimized solution to the particular set of values for the input parameters, there are often other considerations in which the user would not necessarily like to use the optimized solution.

In an embodiment, advantageously, the user interface includes various mechanisms allowing the user to adjust input parameters. These could include free text input, parameter weighting sliders, clickable and dragable output graphs (which feedback as input), or the like.

The user interface enables the user to adjust the input parameters to see, in real-time, how the variance in input parameters affects the representation of the forecast. The user can adjust the input parameters via the input interface 106. The interface module 120 takes the adjusted input parameters and provides them to the forecasting module 122. The forecasting module 122 takes the adjusted input parameters and determines an adjusted forecast via processing the adjusted input parameters with the machine learning model. The interface module 120 generates an adjusted representation of the adjusted forecast. The interface module 120 can display the adjusted representation to the user via the output interface 108.

In further cases, the interface module 120 can repeatedly receive adjusted input parameters for the system 100 to repeatedly produce adjusted representations, as above. In this way, the user can gain valuable insight into how adjustments of certain input parameters vary the forecasts. This ability is particularly advantageous because there may be extrinsic circumstances or influences that require the input parameters to be modified from those which optimize the forecast.

In some cases, the interface module 120 can display the adjusted representation along with the optimized representation, a previous optimization, or another representation.

In some cases, the interface module 120 can display the adjusted representation along with certain artifacts which are associated with the optimized representation or another optimization. As an example, showing a dotted line representing a value of the optimized representation on a graph of the adjusted representation.

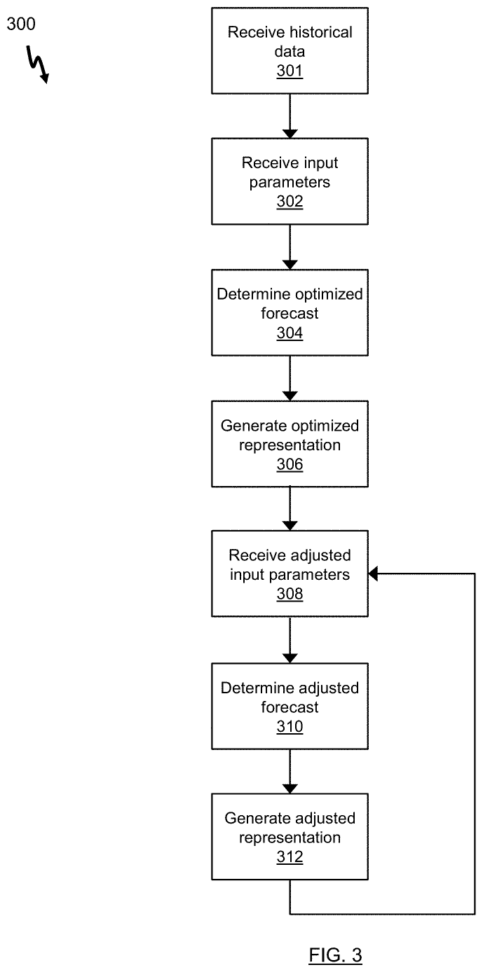

Turning to FIG. 3, a flowchart 300 of a method for generation of adjustable automated forecasts for a promotion, in accordance with an embodiment, is shown.

At block 301, the system 100 retrieves or receives historical data related to the product and a plurality of previous promotions and their respective parameters.

At block 302, the system 100 receives at least one input parameter regarding the promotion from a user via the input interface 106. The input interface 106 can include, for example, a keyboard, a mouse, a touchscreen, or the like.

At block 304, the forecasting module 122 determines an optimized forecast by applying the input parameters to the machine learning model. The machine learning model is trained or instantiated with a training set. The training set includes the received historical data and the at least one input parameter. The forecasting module 122, using the machine learning model, produces a set of forecasts each based on different parameters, and determines at least one set of optimized parameters that maximize an outcome measure of the forecast for the promotion. The outcome measure can be, for example, a measure of product uplift, product sales target, product demand target, or the like.

In further embodiments, the system 100 does not receive initial input parameters from the user, at block 302, but rather determines input parameters that optimize the forecast by having the forecasting module 122 determine such input parameters using the machine learning model. In further cases, the system 100 can receive only one or more input parameters from the user via the input interface 106. The remaining input parameters can be determined such that they optimize the forecast by having the forecasting module 122 determine such remaining input parameters using the machine learning model.

At block 306, the interface module 120 generates a representation of the forecast having the maximized outcome measure and the parameters; which are displayed to the user via the output interface 108.

At block 308, the interface module 120 receives an adjustment to at least one of the parameters from the user via the input interface 106.

At block 310, the forecasting module 122 determines an adjusted forecast by applying the adjustment of the parameters to the machine learning model.

At block 312, the interface module 120 generates a representation of the adjusted forecast and parameters, which is displayed to the user via the output interface 108.

In some cases, there is a return to block 308 to receive further adjusted input parameters.

In some cases, adjustment of the input parameters can include, for example, an adjustment to an input parameter's value, a removal of an input parameter, a removal of some portion of possible states of the input parameter, an inclusion of a further input parameter, adjusting the weighting given to an input parameter by the machine learning model, or the like.

In some cases, the forecasting module 122 can be a set of data mining and machine learning building blocks, working in conjunction with the other modules, to generate the outcome measures; the outcome measures being predictive or explanatory scores of the outcomes of the promotion. The scores can be based on the historical data, as described above. Both supervised and unsupervised learning techniques can be used in generating the scores. These scores are then used to determine the forecast.

In some cases, the forecasting module 122 can be instantiated for each brand new set of data it receives. Prior advertising materials data can be imported into the system 100 to enable the forecasting module 122 to benefit from prior experience. This instantiation step is a mix of constrained optimization and conditional rules. As an example, a reason the forecasting module 122 may be instantiated is because it does not have a base of decisions from which to learn what maximizes the outcomes. There needs to be a base of matches for the reinforcement learning capability to have enough data to actually learn. In other cases, the forecasting module 122 can be seeded with historical data from which inferences can be drawn, enabling reinforcement learning to be employed using the historical data prior to the collection of further input parameters. That is, where previous outcomes exist, and that data is readily available and interpretable, the instantiation phase can be skipped entirely in favor of implementing the machine learning.

In an example, beyond instantiation, the steady state of the forecasting module 122 can shift over to a reinforcement learning hybrid approach. As further data is collected by the system 100, the machine learning model is re-trained and re-scored, and, as a result, new predictions are made for the forecast. This reinforcement learning and feedback approach can be invoked repeatedly to further hone the machine learning model.

In some cases, the machine learning technique used can prioritize learning in an environment whose outcomes can be considered as being partly due to randomness and partly due to phenomena under the control of the system 100 or the user. For example, some input parameters have undoubted causal relationship to outcomes, however, there may be other random factors which may have contributed to those outcomes.

In embodiments, the components of the system are stored by and executed on a single computer system. In other embodiments, the components of the system 100 are distributed among two or more computer systems that may be locally or globally distributed.

In some cases, the forecasting module 122 can change or re-train the models with which the scores themselves are being calculated. In some cases, the forecasting module 122 can perform reinforcement learning “concurrently” with the receiving of outcome data via various channels, enabling the forecasting module 122 to continue to learn the outcomes and adjust forecasts accordingly. This, generally, with enough interaction history, the forecasting module 122 can be considered an artificially intelligent agent.

An intended advantage of the embodiments described herein is to solve the technological problem of being able to adjust an optimized “black box”. In some circumstances, an optimized forecast or solution may not be palatable to the user for a variety of reasons. In this case, a de-optimized solution or forecast may align better with the user's goals or situation. However, often there is so much data in consideration by a system, especially one that implements a machine learning model, that it is practically unfeasible for a person to be able to know how changing some input parameters will affect the optimized solution or forecast; especially for laymen who are not data scientists nor accustomed to dealing with large data. Accordingly, Applicant recognized the substantial advantages of a technical solution whereby a user can, in real-time, appreciate the impacts of changing input parameters on a machine learning modelled solution or forecast.

As an example of the embodiments described herein, a user can use the systems and methods to adjust a forecast of the results of a retail promotion.

Promotions are a frequently used marketing tool undertaken by companies, such as manufacturers, retailers, and service providers. Promotions can be used to raise customer awareness of a product or brand, generating increases in sales or other business metrics. When companies decide to undertake a promotion of one or more products or services, there are a multitude of variables and choices that can be considered. This matrix of variables increases the complexity of making choices with respect to the promotions.

Conventionally, in order to decide on such promotion variables, a marketing professional would use his or her best judgement and experience to choose the aspects of the promotion. From these choices, the marketing professional can attempt to provide an educated guess at determining the potential results of the promotion. However, such educated guess is generally only based on the anecdotal experience and training of the marketing professional. As such, such conventional approach is generally not particularly analytical nor statistically selective at determining promotion outcomes

Promotions can come in many flavors and types, for example, directed personal selling, general advertising, sales promotion, direct marketing, and general publicity awareness. In a particular subset of promotions, promotion can be used to increase sales of a particular product or set of products. Such types of promotions can include various tactics to increase sales, for example, temporarily reducing the price of a product, temporarily increasing the volume of product sold for a given price, combining a product with another product, or the like. However, there are a variety of variables that can affect the outcome of such a promotion. Forecasting such outcome metrics with the input parameters can provide to be useful and statistically relevant for the company undertaking the promotion.

The historical data that the forecasting module 122 use to train the machine learning model can be gathered from a variety of sources and users, and include, for example, input parameters regarding previous promotions and the results of such previous promotions. For example, the cost of the promotion, the avenues for the promotion, the products placed on promotion, the recipients of the promotion, the seasonality of the promoted products, the sales price of the promoted products, the category of the promoted products, the brand of the promoted products, the target of the promoted products, or the like. The results of the promotion can be, for example, the increase in sales of the promoted products, the increase in revenue or profit due to the promoted profit, the halo effect on other products, the pull forward effect on the product, the cannibalization effect on other products, or the like. The forecasting module 122 uses the historical data to train the machine learning model such that the machine learning model can be used to make forecasts and/or predictions regarding the likely effect of a promotion. In further cases, a previously trained machine learning model may be used.

In this example, the input interface 106 receives input parameters from a user, the user being, for example, a company representative looking to put on a promotion of one of its products. The input parameters can be, for example, any number of input parameters regarding the promotion described above.

The forecasting module 122 determines an optimized solution, for the promotion outcomes described above, using the trained machine learning model, and forecasts the outcomes of the promotion based on such optimized solution.

The interface module 120 generates a representation of the forecast determined by the forecasting module 122. For example, in this case, a graph predicting how the promotion will affect the sales of the promoted product over time. The interface module 120 presents this graph to the user via the output interface 108.

The user can then provide adjustments to the input parameters to understand how such adjustments will affect the forecast for the product promotion. For example, the user can change input parameters to limit who will receive the promotion, perhaps not wanting to send this promotion to a certain segment of customers due to over-promotion and an associated negative perception. The interface module 1204 receives this adjustment to the input parameters via the input interface 106. The interface module 1204 communicates the adjusted input parameters to the forecasting module 122, and the forecasting module 122 determines an adjusted forecast based on the adjusted input parameters. While the adjusted forecast is no longer optimized in a strict sense, the adjusted forecast is an adjusted optimization analytic advantageously reflecting extrinsic concerns, requests or desires of the user.

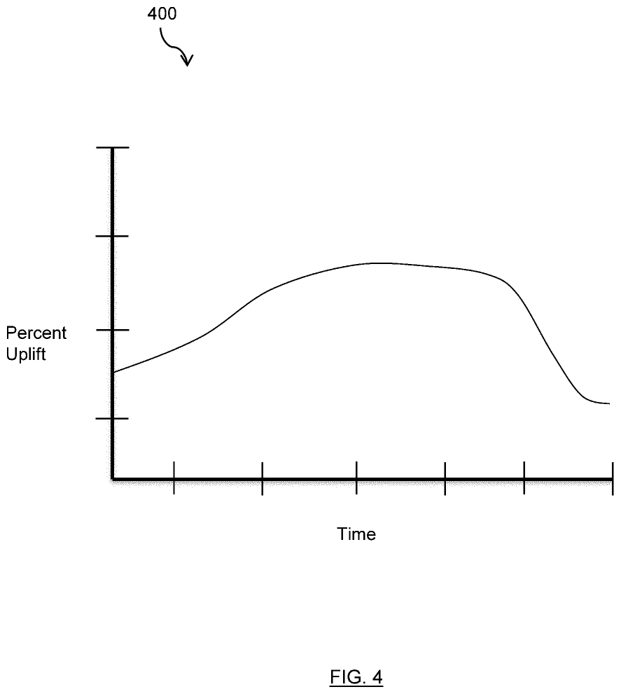

The interface module 120 generates a representation of the adjusted forecast determined by the forecasting module 122. In this case, as shown in FIG. 4, a graph predicting how the promotion will affect the sales of the promoted product over time without consideration to the customers excluded by the user. The interface module 120 presents this graph to the user via the output interface 108. In this way, the user can gain valuable insight by immediately understanding how excluding these customers will affect the predicted promotion outcomes. In some cases, the optimized forecast representation can be overlaid or underlaid on the adjusted representation. In other cases, the graph of the optimized forecast can be presented next to the graph of the adjusted forecast.

Further, if the user is desirous to understand how other input parameters affect the forecast, he or she can adjust such variables on the input interface 106. In some cases, these adjusted parameters can be combined for a total adjusted forecast of the promotion. In other cases, each of the adjusted parameters can be considered independently to understand how each affects the predicted forecast of the promotion.

In further embodiments, two or more product promotions can be considered to see how the promotion of each product will affect each other; and how adjustment of input parameters will affect each of the promotions.

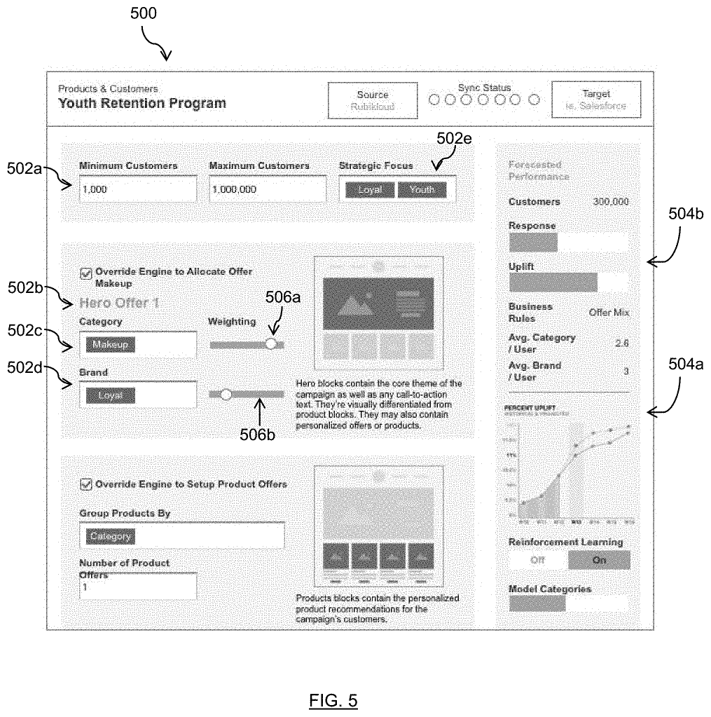

Turning to FIG. 5, there is shown an illustration of a user interface 500, having an input and output interface, according to an exemplary embodiment. There is provided to a user spaces to provide one or more input parameters 502; in this case, via a first input parameter 502a, a second input parameter 502b, a third input parameter 502c, a fourth input parameter 502d, and a fifth parameter 502e. In this example, the first input parameter 502a represents a quantity of customers for the promotion; in the case as shown, between 10000 and 100000 customers. Further, in this example, the second input parameter 502b represents a quantity of promotions (called “hero offers”); in the case as shown, equal to one promotion. Further, in this example, the third input parameter 502c represents the category of goods for the promotion; in the case as shown, in the make-up category. Further, in this example, the fourth input parameter 502d represents the brand of the promoted goods; in the case as shown, for the brand ‘Abex’. Further, in this example, the fifth parameter represents strategic focus considerations of the promotion; in the case as shown, the considerations are for loyalty, youth, and high risk customers.

In this example, the third input parameter 502c includes a first weighting input parameter 506a (as a sliding scale) and the fourth input parameter 502d includes a second weighting input parameter 506b to signify to the forecasting module 122 the amount of weight to give those input parameters respectively in the machine learning model.

In further cases, if there are two or more promotions, each promotion can have a separate category of goods for the promotion input parameter and brand of the promoted goods input parameter.

There is also shown to the user, a representation of a forecast determined by the system 100; in this example, a first graph 504a (dual-axis graph) showing the percent uplift of the promoted product over time. In this example, as part of the forecast, there is also shown to the user a second graph 504b (bar graph) showing the forecasted average uplift and average response. In some cases, as the user changes an input parameter 503, the graph 504 automatically adjusts in real-time. In other cases, the graph 504 only adjusts when a submission acknowledgement is provided by the user. In some cases, the optimized forecast can be shown as a dotted line on the first graph 504a.

In this example, as the user adjusts the input parameters, the graph 504 will adjust in real-time. For example, should the user not care as much about the category limitations of the third input parameter 502c, the user can downwards adjust the first weighting input parameter 506a. The graph 504 is adjusted in real time to reflect the downward adjusted weighting of the third input parameter 502c. The user can use this immediate information provided by the representation to understand the effect of the categories on the forecast. In this manner, the system 100 advantageously provides the user with adjusted forecasts. Thus, the system 300 solves the technological problem of being able to easily change and adjust machine learning modelled forecasts without having to use costly and time consuming data science reprogramming and related techniques.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

1. A computer-implemented method for generation of adjustable automated forecasts for a promotion, the method comprising:
receiving historical data related to one or more products and a plurality of previous promotions and their respective parameters;
receiving at least one input parameter for the promotion from a user;
determining, using a machine learning model trained or instantiated with a training set, a set of forecasts each based on different parameters, and determining at least one set of optimized parameters that maximize an outcome measure of the forecast for the promotion, the training set comprising the received historical data and the at least one input parameter;
generating a graphical representation of the forecast having the maximized outcome measure;
outputting the at least one input parameter, at least one optimized parameter, and the graphical representation of the forecast to the user;
receiving an adjustment to at least one of the input parameters or at least one of the optimized parameters from the user;
determining an adjusted outcome measure of the forecast for the promotion by applying the adjustment to the machine learning model;
generating an adjusted graphical representation of the forecast having the adjusted outcome measure; and
displaying the adjusted graphical representation to the user.

2. The method of claim 1, further comprising receiving a subsequent adjustment to at least one of the input parameters or at least one of the optimized parameters from the user, and performing:
determining a subsequent adjusted outcome measure of the forecast for the promotion by applying the subsequent adjustment to the machine learning model;
generating a subsequent adjusted graphical representation of forecast having the subsequent adjusted outcome measure; and
displaying the subsequent adjusted graphical representation to the user.

3. The method of claim 1, wherein the adjustment to the at least one of the input parameters or the at least one of the optimized parameters comprises removal of at least one of the input parameters or the optimized parameters.

4. The method of claim 1, wherein the adjustment to the at least one of the input parameters or the at least one of the optimized parameters comprises changing a value of at least one of the input parameters or the optimized parameters.

5. The method of claim 1, wherein the adjustment to the at least one of the input parameters or the at least one of the optimized parameters comprises changing weighting given to at least one of the input parameters or the optimized parameters by the machine learning model.

6. The method of claim 1, wherein the adjustment to the at least one of the input parameters or the at least one of the optimized parameters comprises filtering possible states of the input parameters or the optimized parameters.

7. The method of claim 1, wherein the machine learning model used to generate the forecasts can include one or more of predictive modeling, sensitivity analysis, basket analysis, root cause analysis, and regression analysis.

8. A system for generation of adjustable automated forecasts for a promotion, the system comprising one or more processors and a data storage device, the one or more processors configured to execute:
an interface module to receive at least one input parameter for the promotion from a user; and
a forecasting module to determine, using a machine learning model trained or instantiated with a training set, a set of forecasts each based on different parameters, and to determine at least one set of optimized parameters that maximize an outcome measure of the forecast for the promotion, the training set comprising a set of received historical data and the at least one input parameter,
wherein the interface module generates a graphical representation of the forecast having the maximized outcome measure and outputs the at least one input parameter, at least one optimized parameter, and the graphical representation of the forecast to the user, the interface module receiving an adjustment to at least one of the input parameters or at least one of the optimized parameters from the user,
wherein the forecasting module determines an adjusted outcome measure of the forecast for the promotion by applying the adjustment to the machine learning model, and
wherein the interface module generates an adjusted graphical representation of the forecast having the adjusted outcome measure and displays the adjusted graphical representation to the user.

9. The system of claim 8, wherein the interface module further receives a subsequent adjustment to at least one of the input parameters or at least one of the optimized parameters from the user, and wherein the forecasting module further determines a subsequent adjusted outcome measure of the forecast for the promotion by applying the subsequent adjustment to the machine learning model, the interface module generating a subsequent adjusted graphical representation of forecast having the subsequent adjusted outcome measure and displaying the subsequent adjusted graphical representation to the user.

10. The system of claim 8, wherein the adjustment to the at least one of the input parameters or the at least one of the optimized parameters comprises removal of at least one of the input parameters or the optimized parameters.

11. The system of claim 8, wherein the adjustment to the at least one of the input parameters or the at least one of the optimized parameters comprises changing a value of at least one of the input parameters or the optimized parameters.

12. The system of claim 8, wherein the adjustment to the at least one of the input parameters or the at least one of the optimized parameters comprises changing weighting given to at least one of the input parameters or the optimized parameters by the machine learning model.

13. The system of claim 8, wherein the adjustment to the at least one of the input parameters or the at least one of the optimized parameters comprises filtering possible states of the input parameters or the optimized parameters.

14. The system of claim 8, wherein the machine learning model used to generate the forecasts can include one or more of predictive modeling, sensitivity analysis, basket analysis, root cause analysis, and regression analysis.
